(19) United States
(12) Patent Application Publication
(10) Pub. No.: US 2009/0105931 A1
(43) Pub. Date: Apr. 23, 2009

(54) CONTROLLER FOR INTERNAL COMBUSTION ENGINE

(75) Inventor: Hidehiko Asama, Toyota-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/252,528

(22) Filed: Oct. 16, 2008

(30) Foreign Application Priority Data
Oct. 18, 2007 (JP) 2007-270911

(51) Int. Cl. F02D 41/30

(52) U.S. Cl. 701/104

(57) ABSTRACT

A computer determines whether fuel is supplied to the fuel tank while the engine is stopped. When Yes, an injection quantity varying control is performed immediately after the engine is started in which the fuel injection quantity is varied with respect to each cylinder by correcting the fuel injection quantity by use of the air-fuel-ratio learning correction value that is learned in the previous engine operation and a varying correction value which is particular value with respect to each cylinder. The computer determines a combustion condition in each cylinder (for example, a fluctuation in rotational speed in each cylinder), and computes the varying correction value which is appropriate for the supplied fuel. The air-fuel-ratio learning correction value is computed based on the varying correction value.

### CROSS-REFERENCE TO RELATED APPLICATION

This application is based on Japanese Patent Application No. 2007-270911 filed on Oct. 18, 2007, the disclosure of which is incorporated herein by reference.

### FIELD OF THE INVENTION

The present invention relates to a controller for an internal combustion engine, which corrects fuel injection quantity by use of an air-fuel-ratio learning correction value that is learned during an air-fuel-ratio feedback control.

### BACKGROUND OF THE INVENTION

In an electronically controlled engine, when a specified execution condition for air-fuel-ratio feedback control is established, an air-fuel-ratio feedback control is performed so that the air-fuel ratio of an exhaust gas agrees with a target air-fuel ratio (a stoichiometric air-fuel ratio). During the air-fuel-ratio feedback control, air-fuel-ratio learning correction value is learned. Before the air-fuel-ratio feedback control is performed immediately after the engine is started, the fuel injection quantity is corrected by use of the air-fuel-learning correction value which is learned during a previous air-fuel-ratio feedback control, so that the air-fuel ratio is controlled toward the target air-fuel ratio even before the air-fuel-ratio feedback control is started.

In a specified engine, gasoline, alcohol such as ethanol and methanol, and mixture fuel of gasoline and alcohol can be used as fuel. In such an engine, there is a possibility that a fuel different from previous supplied fuel is supplied to the fuel tank, whereby an alcohol concentration (or gasoline concentration) of the fuel may vary. Generally, the stoichiometric air-fuel ratio is different between gasoline and alcohol. Thus, when the alcohol concentration is varied, the appropriate air-fuel ratio where a stable combustion can be obtained is also varied.

In a case that a different kind of fuel is supplied during the engine stop such that the alcohol concentration is varied, if the fuel injection quantity is corrected by use of the air-fuel-ratio learning correction value which is learned during the previous control, a suitable air-fuel ratio for the varied alcohol concentration can not be obtained, which may deteriorate the drivability and the emission.

In an engine control system shown in JP-63-12853A, when the fuel supply is detected and the engine is started, it is assumed that a specified fuel (for example, alcohol of 100%) is supplied to the fuel tank and a fuel correction value is estimated. The fuel injection quantity is corrected by use of the estimated fuel correction value.

However, the air-fuel ratio can not be controlled so as to be suitable for the actual alcohol concentration after the fuel supply, which may deteriorate the drivability and the emission.

### SUMMARY OF THE INVENTION

The present invention is made in view of the above matters, and it is an object of the present invention to provide a controller for an internal combustion engine, which is capable of correcting a fuel injection quantity by use of a correction value suitable for a supplied fuel from a beginning of engine operation.

According to the present invention, a controller corrects a fuel injection quantity by use of an air-fuel-ratio learning correction value that is learned during an air-fuel-ratio feedback control. The controller includes a fuel supply determination means for determining whether a fuel is supplied to a fuel tank during an engine stop and an injection quantity varying control means for performing an injection quantity varying control. In the injection quantity varying control, a fuel injection quantity is adjusted with respect to each cylinder by correcting the fuel injection quantity by use of the air-fuel-ratio learning correction value that is learned during a previous engine operation and a varying correction value that is particular to each cylinder. The injection quantity varying control is performed after the engine is started in a case that the fuel supply determination means determines that the fuel is supplied to the fuel tank. The controller further includes a combustion condition determination means for determining a combustion condition in each cylinder, and a changing means which obtains a varying correction value suitable for the fuel based on the combustion condition determined by the combustion condition determination means. The changing means changes or corrects the air-fuel-ratio learning correction value based on the varying correction value.

When the injection quantity varying control is performed by use of the varying correction value that is particular to each cylinder the combustion condition becomes better as the varying correction value come close to an appropriate value that brings the air-fuel ratio to an appropriate value according to the alcohol concentration after the fuel is supplied. Thus, the appropriate air-fuel-ratio learning correction value can be computed by evaluating the combustion condition in each cylinder and the varying correction value with respect to each cylinder. Thereby, even if the fuel is supplied to the fuel tank while the engine is stopped so that the alcohol concentration is varied, the fuel injection quantity is corrected by use of the air-fuel-ratio learning correction value appropriate for the alcohol concentration before the air-fuel ratio feedback control is started. Thus, an appropriate air-fuel ratio can be obtained, so that the drivability can be improved and the emission can be reduced.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of an engine control system according to an embodiment of the present invention;

FIG. 2 is a flowchart showing a process of a fuel supply determination routine;

FIG. 3 is a flowchart showing a process of an injection quantity varying control routine;

FIG. 4 is a flowchart showing an air-fuel-ratio learning correction value changing routine;

FIG. 5 is a chart for explaining a relationship between the air-fuel-ratio learning correction value and a combustion condition

FIG. 6 is a chart for explaining a method for establishing a varying correction value for each cylinder; and

FIG. 7 is a time chart showing a process of an air-fuel-ratio learning correction value changing.

### DETAILED DESCRIPTION OF EMBODIMENTS

An embodiment of the present invention will be described hereinafter.

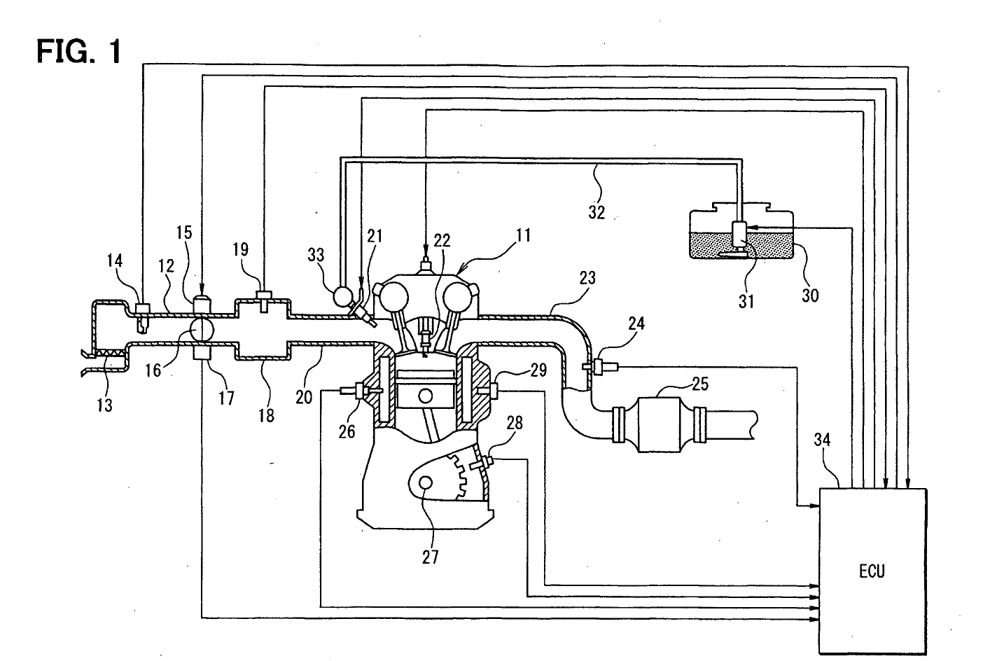

Referring to FIG. 1, an engine control system is explained. A three-cylinder engine 11 has a first cylinder #a, a second cylinder #b, and a third cylinder #c. An air cleaner 13 is arranged upstream of an intake pipe 12 of an internal combustion engine 11. An airflow meter 14 detecting an intake air flow rate is provided downstream of the air cleaner 13. A throttle valve 16 driven by a DC-motor 15 and a throttle position sensor 17 detecting a throttle position (throttle opening degree) are provided downstream of the air flow meter 14.

A surge tank 18 including an intake air pressure sensor 19 is provided downstream of the throttle valve 16. The intake air pressure sensor 19 detects intake air pressure. An intake manifold 20 which introduces air into each cylinder of the engine 11 is provided downstream of the intake pipe 12, and the fuel injector 21 which injects the fuel is provided at a vicinity of an intake port of the intake manifold 20 of each cylinder. A spark plug 22 is mounted on a cylinder head of the engine 11 corresponding to each cylinder to ignite air-fuel mixture in each cylinder.

An exhaust gas sensor (an air fuel ratio sensor, an oxygen sensor) 24 which detects an air-fuel ratio of the exhaust gas is respectively provided in each exhaust pipe 23, and a three-way catalyst 25 which purifies the exhaust gas is provided downstream of the exhaust gas sensor 24.

A coolant temperature sensor 26 detecting a coolant temperature and a knock sensor 29 detecting a knocking of the engine are disposed on a cylinder block of the engine 11. A crank angle sensor 28 is installed on a cylinder block to output crank angle pulses when a crank shaft 27 rotates a predetermined angle. Based on this crank angle pulses, a crank angle and an engine speed are detected.

The engine 11 can use gasoline, alcohol such as ethanol and methanol, or mixture fuel of gasoline and alcohol. Any one of gasoline, alcohol, and mixture fuel is supplied to the engine 11. A fuel pump 31 which pumps up the fuel is provided in a fuel tank 30 which stores the fuel. The fuel discharged from the fuel pump 31 is sent to a delivery pipe 33 through a fuel supply pipe 32, and is distributed to a fuel injector 21 of each cylinder from this delivery pipe 33.

The outputs of the sensors are inputted to an electronic control unit (ECU) 34. The ECU 34 includes a microcomputer which executes an engine control program stored in a Read Only Memory (ROM) to control a fuel injection quantity of a fuel injector 21 and an ignition timing of a spark plug 22 according to an engine running condition.

When an air-fuel-ratio feedback control execution condition is established during an engine operation, the ECU 34 computes an air-fuel-ratio feedback correction value so that an air-fuel ratio in the exhaust gas agrees with a target air-fuel-ratio (for example, stoichiometric ratio). The air-fuel-ratio feedback control is performed by use of the air-fuel-ratio feedback correction value in order to correct the fuel injection quantity.

The ECU 34 learns a correction value of the fuel injection quantity (air-fuel-ratio feedback correction value) during the air-fuel-ratio feedback control. The learned correction value of the fuel injection quantity is stored in a nonvolatile memory such as a Backup RAM as the air-fuel-ratio learning correction value.

Before the air-fuel-ratio control is started immediately after the engine is started, the ECU 34 corrects the fuel injection quantity by used of the air-fuel-ratio learning correction value which is learned in a previous engine operation, so that the air-fuel ratio can be controlled to be close to the target air-fuel ratio even before the air-fuel-ratio feedback control is started.

In an engine system where any one of gasoline, alcohol, and mixture fuel can be used as fuel, there is a possibility that a fuel different from previous supplied fuel is supplied to the fuel tank 30, whereby an alcohol concentration (or gasoline concentration) of the fuel may varies. Generally, a stoichiometric ratio is different between gasoline and alcohol. Thus, when the alcohol concentration of the fuel is varied, the stoichiometric ratio is also varied. An appropriate air-fuel ratio for obtaining an appropriate combustion is also varied.

If a different kind of fuel is supplied during an engine stop, the alcohol concentration of the fuel is varied. Before the air-fuel-ratio control is started immediately after the engine is started, the ECU 34 corrects the fuel injection quantity by used of the air-fuel-ratio learning correction value which is learned in a previous engine operation. However, such a configuration can not control the air-fuel ratio according to the alcohol concentration, whereby a drivability and an emission may be deteriorated.

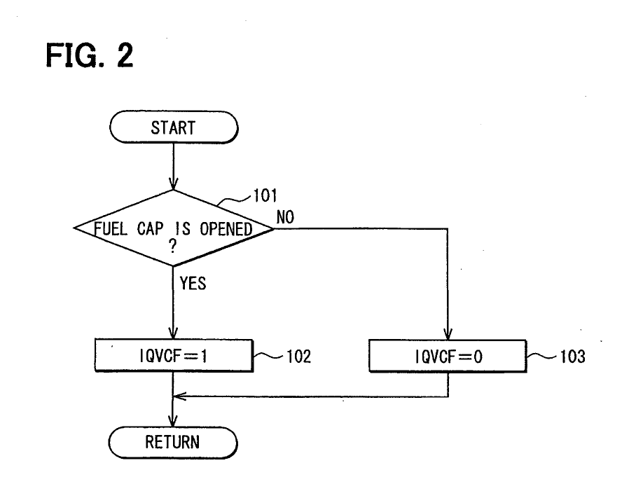

The ECU 34 performs each routine shown in FIGS. 2 to 4 to determine whether fuel is supplied to the fuel tank 30 while the engine is stopped. When it is determined that the fuel is supplied to the fuel tank 30 while the engine is stopped, an injection quantity varying control (IQVC) is performed immediately after the engine is started, in which the fuel injection quantity is varied with respect to each cylinder by correcting the fuel injection quantity by use of the air-fuel-ratio learning correction value that is learned in the previous engine operation and a varying correction value which is particular value with respect to each cylinder. The ECU 34 determines a combustion condition in each cylinder (for example, a fluctuation in rotational speed in each cylinder), and computes the varying correction value which is appropriate for the supplied fuel. The air-fuel-ratio learning correction value is varied or corrected based on the varying correction value.

When the injection quantity varying control (IQVC) is performed by use of the varying correction value that is particular to each cylinder, the combustion condition becomes better as the varying correction value come close to an appropriate value that brings the air-fuel ratio to an appropriate value according to the alcohol concentration after the fuel is supplied. Thus, the appropriate air-fuel-ratio learning correction value can be computed by evaluating the combustion condition in each cylinder and the varying correction value with respect to each cylinder. Thereby, even if the alcohol concentration in the fuel is varied, the fuel injection quantity can be corrected by use of the air-fuel-ratio learning correction value which is appropriate for the varied alcohol concentration after the fuel is supplied even immediately after the engine is started.

Referring to FIGS. 2 to 4, the processes of each routine for varying the air-fuel-ratio learning correction value will be described.

### [Fuel Supply Determination Routine]

FIG. 2 is a flow chart showing a fuel supply determination routine. This routine is executed at a specified cycle while the ECU 34 is ON, and corresponds to a fuel supply determination means. In step 101, the computer determines whether the fuel is supplied to the fuel tank 30 while the engine is stopped based on whether a fuel cap is opened while the engine is stopped. In this case, a control circuit (not shown) equipped with a vehicle detects whether the fuel cap is opened. After the ECU 34 is turned ON, the ECU 34 receives the signal from the control circuit to determine whether the fuel cap is opened. Alternatively, while the engine is stopped, the ECU 34 can determine whether the fuel cap is opened based on an output of a sensor which detects an opening of the fuel cap.

Alternatively, the computer determines whether the fuel is supplied while the engine is stopped based on a variation in a fuel quantity remaining in the fuel tank 30.

When the answer is Yes in step 101, the procedure proceeds to step 102 in which an injection quantity varying control execution flag (IQVCF) is set to “1”.

When the answer is No in step 101, the procedure proceeds to step 103 in which the injection quantity varying control execution flag (IQVCF) is set to “0”.

### [Injection Quantity Varying Control Routine]

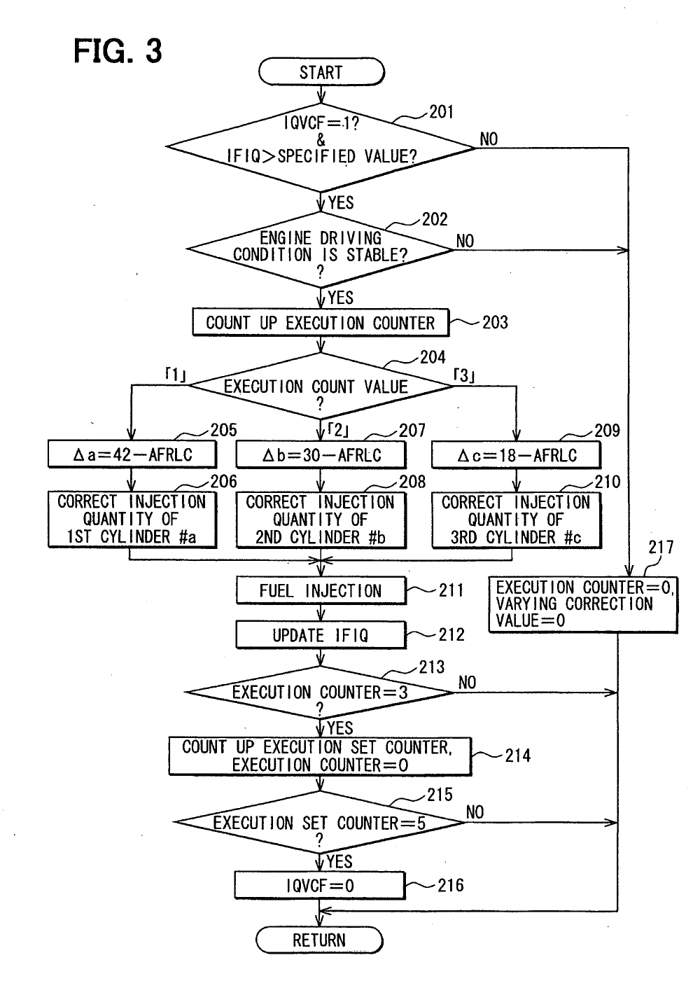

FIG. 3 is a flow chart showing an injection quantity varying control routine, which is executed at fuel injection timing while the ECU 34 is ON. This routine corresponds to an injection quantity varying control means. In step 201, the computer determines whether the IQVCF is set to “1” and whether an integrated fuel injection quantity (IFIQ) from the engine start exceeds a specified value. The specified value corresponds to a volume of a fuel supply passage from the fuel pump 31 in the fuel tank 31 to the fuel injector 21. Alternatively, the specified value is slightly greater than the volume of the fuel supply passage. Thus, it can be determined whether the fuel in the fuel tank 30 can be injected through the fuel injector 21 based on whether the IFIQ exceeds the specified value.

When the answer is No in step 201, the procedure proceeds to step 217 in which an execution counter is maintained at “0” and the varying correction value is maintained at “0” to end the routine. In this case, the injection quantity varying control (IQVC) is not executed.

When the answer is Yes in step 201, the procedure proceeds to step 202 in which the computer determines whether the engine start is completed and an engine driving condition (for example, the accelerator position, the throttle position, the intake air flow rate, and the like) is stable. When the answer is Yes in step 202, the procedure proceeds to step 203.

In step 203, a count value of the execution counter is counted up by “1” (an initial value is “0”), and then the procedure proceeds to step 204. In step 204, the computer determines any of “1” to “3” the count value of the execution counter is.

When it is determined that the count value is “1”, the procedure proceeds to step 205 in which the varying correction value Δa of the first cylinder #a is established according to the following equation by use of a first specified value “42%” and the air-fuel-ratio learning correction value (AFRLC) learned in the previous engine operation.

The varying correction value Δa=42−Air-fuel-ratio learning correction value(AFRLC)(%)

Then, the procedure proceeds to step 206 in which the fuel injection quantity of the first cylinder #a is corrected by used of the AFRLC and the Δa of the first cylinder #a. In this case, the fuel injection quantity of the first cylinder #a is corrected by use of a final correction value (AFRLC+Δa). Then, the procedure proceed to step 211 in which the fuel injection of the first cylinder #a is performed.

When it is determined that the count value is “2” in step 204, the procedure proceeds to step 207 in which the varying correction value Δb of the second cylinder #b is established according to the following equation by use of a second specified value “30%” and the air-fuel-ratio learning correction value (AFRLC) learned in the previous engine operation.

The varying correction value Δb=30−Air-fuel-ratio learning correction value(AFRLC)(%)

Then, the procedure proceeds to step 208 in which the fuel injection quantity of the second cylinder #b is corrected by used of the AFRLC and the Δb of the second cylinder #b. In this case, the fuel injection quantity of the second cylinder #b is corrected by use of a final correction value (AFRLC+Δb). Then, the procedure proceeds to step 211 in which the fuel injection of the second cylinder #b is performed.

When it is determined that the count value is “3” in step 204, the procedure proceeds to step 209 in which the varying correction value Δc of the third cylinder #c is established according to the following equation by use of a third specified value “18%” and the air-fuel-ratio learning correction value (AFRLC) learned in the previous engine operation.

The varying correction value Δc=18−Air-fuel-ratio learning correction value(AFRLC)(%)

The first specified value “42”, the second specified value “30”, and the third specified value “18” can be arbitrarily changed as long as these values are different from each other.

Then, the procedure proceeds to step 210 in which the fuel injection quantity of the third cylinder #c is corrected by used of the AFRLC and the Δc of the third cylinder #c. In this case, the fuel injection quantity of the third cylinder #c is corrected by use of a final correction value (AFRLC+Δc). Then, the procedure proceeds to step 211 in which the fuel injection of the third cylinder #c is performed.

As described above, the injection quantity varying control (IQVC) is performed by use of air-fuel-ratio learning correction value and the varying correction values Δa-Δc. The varying correction value Δa-Δc of each cylinder #a-#c is established in such a manner that the air-fuel ratio of at least one cylinder does not exceed a combustion limit at both rich side and lean side with respect to whole range of the alcohol concentration (0%-100%) and the combustion conditions of each cylinder are different from each other.

The way of establishing the varying correction values Δa-Δc will be described hereinafter.

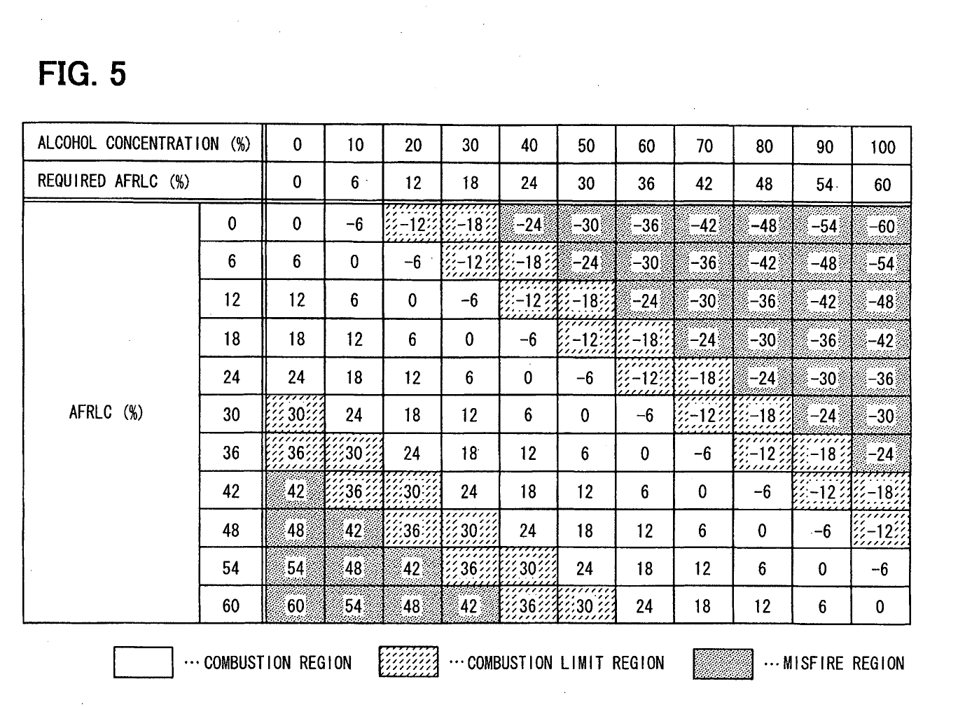

As shown in FIG. 5, since a required air-fuel-ratio learning correction value (required AFRLC) varies according to the alcohol concentration of the fuel, the combustion condition is varied according to a difference between the actual air-fuel-ratio learning correction value (actual AFRLC) and the required air-fuel-ratio learning correction value (required AFRLC). A region in which the difference between the air-fuel-ratio learning correction value (AFRLC) and the required air-fuel-ratio learning correction value (required AFRLC) is from “−10” to “28” is a region where the fuel can be combusted. A region in which the difference between the AFRLC and the required AFRLC is from “28” to “40” and a region in which the difference between the AFRLC and the required AFRLC is from “−10” to “−20” are combustion limit regions. Furthermore, a region in which the difference between the AFRLC and the required AFRLC is greater than or equal to “40” and a region in which the difference between the AFRLC and the required AFRLC is less than or equal to “−20” are misfire regions.

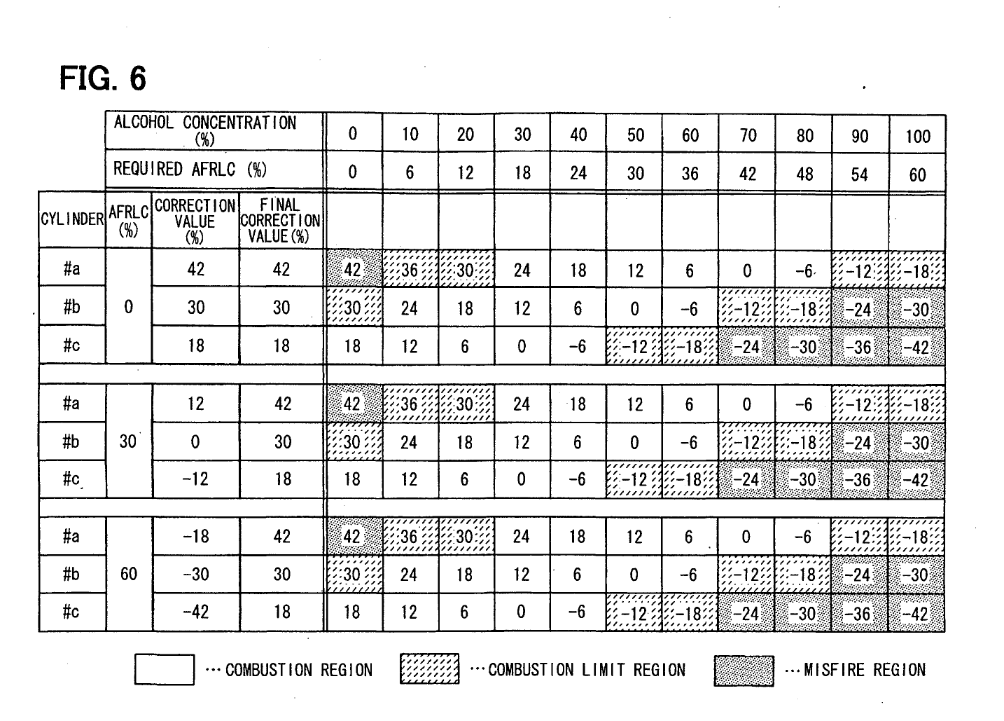

As shown in FIG. 6, the varying correction values Δa-Δc are established in such a manner that a difference between the final correction value (=AFRLC+varying correction value) and the required air-fuel-ratio learning correction value of at least one cylinder is within the combustion region or the combustion limit region. Thereby, the varying correction values Δa-Δc of each cylinder #a-#c are established in such a manner that the air-fuel ratio does not exceed the combustion limit in at least one cylinder with respect to the whole range of the alcohol concentration. The varying correction values Δa-Δc can be established so that the air-fuel ratio does not exceeds the combustion limit with respect to every cylinder.

Furthermore, the varying correction values Δa-Δc are established so that the final correction value of the first cylinder #a is larger than that of the second cylinder #b by “10” or more and the final correction value of the third cylinder #c is smaller than that of the second cylinder #b by “10” or more. Thus, the combustion conditions in each cylinder #a-#c are different from each other.

After the fuel injection is performed in step 211, the procedure proceeds to step 212 in which the integral fuel injection quantity (IFIQ) is updated by adding the current fuel injection quantity to the previous integrated fuel injection quantity. Then, the procedure proceeds to step 213 in which the computer determines whether the injection quantity varying control (IQVC) is performed once in each cylinder #a-#c based on whether the count value of the execution counter reaches the number of the cylinder (“3” in this embodiment).

When it is determined that the count value of the execution counter is “3” in step 213, the computer determines that the injection quantity varying control (IQVC) is performed once in each cylinder #a-#c respectively. The procedure proceeds to step 214 in which a count value of an execution set counter is counted up by “1” (initial value is “0”) and the count value of the execution counter is reset to “0”.

Then, the procedure proceeds to step 215 in which the computer determines whether the count value of the execution set counter is a specified value, for example “5”. When the count value of the execution set counter is “5”, it is determined that the five fuel injections are performed in each cylinder #a-#c respectively. When the answer is No in step 215, the processes in steps 201-215 are repeatedly performed to continue the injection quantity varying control (IQVC) until the count value of the execution set counter becomes “5”.

When the answer is Yes in step 215, the procedure proceeds to step 216 in which the injection quantity varying control execution flag (IQVCF) is reset to “0” to end the injection quantity varying control (IQVC).

### [Air-Fuel-Ratio Learning Correction Value Changing Routine]

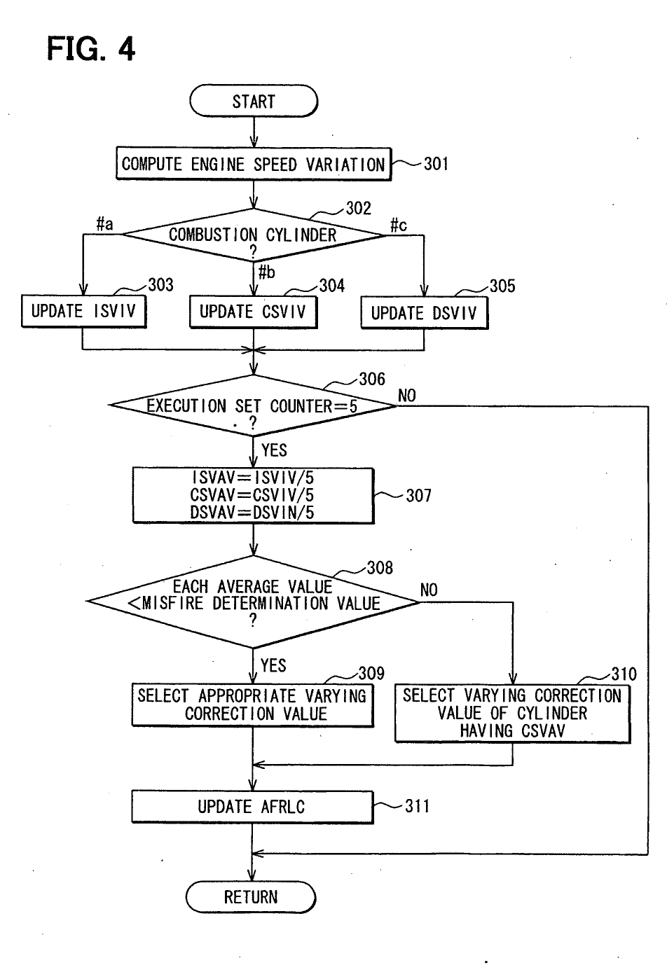

FIG. 4 is a flowchart showing an air-fuel-ratio learning correction value changing routine, which corresponds to an air-fuel-ratio learning correction value changing means. In step 301, when the engine driving condition is stable, the computer computes an engine speed variation due to a combustion in the cylinder in which the injection quantity varying control (IQVC) is performed. The engine speed variation represents a combustion condition in each cylinder in which the injection quantity varying control (IQVC) is performed. The engine speed variation is defined as a difference between an engine speed immediately after the combustion in the cylinder and an engine speed immediately before the combustion in the cylinder. When the engine driving condition is stable, the engine speed variation amount is varied according to the combustion state in each cylinder. Hence, the combustion state in each cylinder is accurately determined by use of the engine speed variation when the engine driving condition is stable.

Then, the procedure proceeds to step 302 in which the computer determines which cylinder is a combustion cylinder. When the computer determines that the first cylinder #a is the combustion cylinder, that is, when the fuel injection quantity in the first cylinder #a is greater than that in the second cylinder #b, the procedure proceeds to step 303. In step 303, an increasing speed variation integral value (ISVIV), that is an integral value of the engine speed variation in the first cylinder #a is updated by adding a current engine speed variation of the first cylinder #a to a previous increasing speed variation integral value. An initial value of the ISVIV is “0”.

When the computer determines that the second cylinder #b is the combustion cylinder in step 302, the procedure proceeds to step 304 in which a center speed variation integral value (CSVIV), that is, an integral value of the engine speed variation in the second cylinder #b is updated by adding the a current engine speed variation of the second cylinder #b to a previous center speed variation integral value. An initial value of the CSVIV is “0”.

When the computer determines that the third cylinder #c is the combustion cylinder, that is, when the fuel injection quantity in the third cylinder #c is lower than that in the second cylinder #b, the procedure proceeds to step 305. In step 305, a decreasing speed variation integral value (DSVIV), that is an integral value of the engine speed variation in the third cylinder #c is updated by adding a current engine speed variation of the third cylinder #c to a previous decreasing speed variation integral value. An initial value of the DSVIV is “0”.

Then, the procedure proceeds to step 306 in which it is determined whether the count value of the execution set counter is a specified value, for example “5”. When the answer is Yes in step 306, the computer determines that an integral number of the engine speed variation of each cylinder #a-#c is “5” and the procedure proceeds to step 307. In step 307, an increasing speed variation average value (ISVAV), a center speed variation average value (CSVAV), and a decreasing speed variation average value (DSVAV) are respectively computed based on following formulas:

ISVAV=ISVIV/5

CSVAV=CSVIV/5

DSVAV=DSVIV/5

Then, the procedure proceeds to step 308 in which the computer determines whether at least one of the ISVAV, the CSVAV, and the DSVAV is lower than a respectively specified misfire determination value, whereby it is determined whether the combustion condition in each cylinder #a-#c is misfire condition respectively. The process in step 308 corresponds to a combustion condition determination means.

When it is determined that any of the ISVAV, the CSVAV and the DSVAV is lower than the misfire determination value, that is, when it is determined that any of cylinders is under the misfire condition, the procedure proceeds to step 309. In step 309, it is determined that a varying correction value which is close to a varying correction value of the misfire determination cylinder is appropriate for the alcohol concentration after the fuel is supplied. This varying correction value is selected as an appropriate varying correction value.

When the answer is No in step 308, that is, when it is determined that no cylinder is under the misfire condition, the procedure proceeds to step 310. In step 310, the varying correction value of the cylinder (second cylinder #b) having the CSVAV is selected as an appropriate varying correction value.

The way of obtaining the appropriate varying correction value is not limited to the way described above. For example, the appropriate varying correction value can be derived from a relationship between the varying correction value in each cylinder #a-#c and the speed variation average value in each cylinder #a-#c.

Then, the procedure proceeds to step 311 in which the air-fuel-ratio learning correction value (AFRLC) appropriate for the alcohol concentration after the fuel is supplied is computed by adding the selected varying correction value to the current air-fuel-ratio learning correction value (AFRLC). That is, the AFRLC is updated.

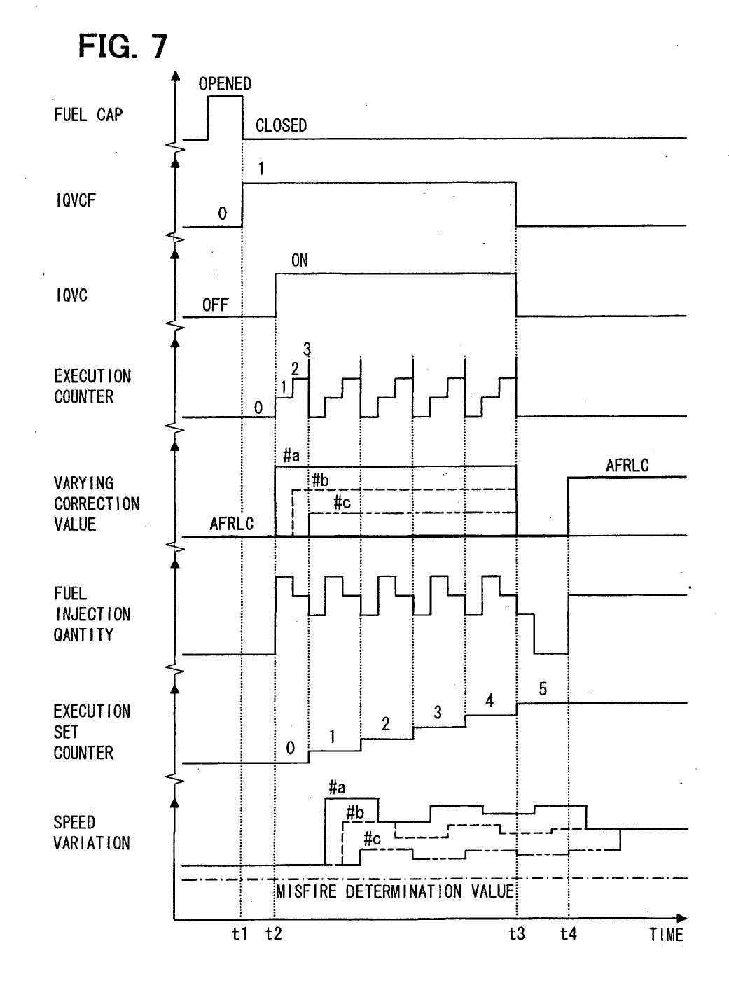

Referring to a time chart shown in FIG. 7, the process of the air-fuel-ratio learning correction value changing will be described. When the state of the fuel cap is changed from the open state to the close state at a time t1, it is determined that the fuel is supplied to the fuel tank 30. The IQVCF is set to “1”. Then, when the IFIQ exceeds a specified value and when it is determined that the engine start is completed and the engine driving condition is stable at a time t2, the injection quantity varying control (IQVC) is started.

In the injection quantity varying control (IQVC), the particular varying correction value is established with respect to each cylinder #a-#c, and the fuel injection quantity is corrected for each cylinder #a-#c by use of the current AFRLC and the varying correction value. When five fuel injections are performed at a time t3, the IQVCF is set to “0” to end the injection quantity varying control (IQVC). The injection quantity varying control (IQVC) is repeatedly performed until five fuel injections are performed in each cylinder.

Then, the engine speed variation due to the combustion in each cylinder is computed and the engine speed variation is integrated. When the integrated number of the engine speed variation in each cylinder #a-#c becomes “5” at a time t4, the average value of the engine speed variation of each cylinder is respectively obtained and is compared with the misfire determination value in order to determine the combustion condition in each cylinder. Based on the determination result, the varying correction value appropriate for the alcohol concentration after the fuel is supplied is computed, and the air-fuel-ratio learning correction value (AFRLC) appropriate for the alcohol concentration is computed by adding the varying correction value to the current AFRLC.

Thereby, even if the fuel is supplied to the fuel tank while the engine is stopped so that the alcohol concentration is varied, the fuel injection quantity is corrected by use of the air-fuel-ratio learning correction value appropriate for the alcohol concentration before the air-fuel ratio feedback control is started. Thus, an appropriate air-fuel ratio can be obtained, so that the drivability can be improved and the emission can be reduced.

According to the present embodiment, when the injection quantity varying control (IQVC) is performed, the varying correction values Δa-Δc of each cylinder #a-#c are established in such a manner that the air-fuel ratio does not exceeds the combustion limit in at least one cylinder with respect to whole range of the alcohol concentration. Thus, it is prevented that the misfire is occurred in all cylinders. Furthermore, the varying correction values #a-Δc are established in such a manner that the combustion conditions in each cylinder #a-#c are different from each other. Hence, the combustion conditions in each cylinder #a-#c are easily evaluated to obtain the air-fuel-ratio learning correction value (AFRLC) which is appropriate for the alcohol concentration after the fuel is supplied to the fuel tank.

Furthermore, according to the present embodiment, the injection quantity varying control (IQVC) is repeatedly performed until the fuel injection is performed the specified times (for example, 5 times). Hence, by use of data of the specified times combustion condition, the combustion condition in each cylinder #a-#c is accurately determined and the air-fuel-ratio learning correction value which is appropriate for the alcohol concentration after the fuel is supplied is accurately obtained.

When the fuel is supplied to the fuel tank 30 so that the alcohol concentration is varied, the fuel remaining in the fuel supply passage between the fuel pump 31 and the fuel injector 21 is injected and then the fuel in the fuel tank 30 is injected. That is, the fuel of which alcohol concentration is not varied is injected first, and then the fuel of which alcohol concentration is varied is injected.

According to the present embodiment, after the integrated value of the fuel injection quantity exceeds the specified value and the fuel in the fuel tank 30 has been injected, the injection quantity varying control (IQVC) is performed. Thus, even if the alcohol concentration in the fuel tank 30 is varied, the air-fuel-ratio learning correction value which is appropriate for the varied alcohol concentration is accurately obtained.

In the above embodiment, the air-fuel-ratio learning correction value is changed only once after the engine is started. Alternatively, the air-fuel-ratio learning correction value can be changed a plurality of times.

In the above embodiment, the combustion condition is determined based on the engine speed variation due to the combustion in each cylinder. Alternatively, the combustion condition can be determined based on the other parameter such as a cylinder pressure variation due to the combustion in each cylinder.

The present invention can be applied to an engine having two cylinders and an engine having four or more cylinders. The present invention is not limited to an intake port injection engine. The present invention can be applied to a direct injection engine or a dual injection engine.

What is claimed is:

1. A controller for an internal combustion engine, which corrects a fuel injection quantity by use of an air-fuel-ratio learning correction value that is learned during an air-fuel-ratio feedback control, the controller comprising:
a fuel supply determination means for determining whether a fuel is supplied to a fuel tank during an engine stop;
an injection quantity varying control means for performing an injection quantity varying control in which a fuel injection quantity is adjusted with respect to each cylinder by correcting the fuel injection quantity by use of the air-fuel-ratio learning correction value that is learned during a previous engine operation and a varying correction value that is particular to each cylinder, the injection quantity varying control being performed after the engine is started in a case that the fuel supply determination means determines that the fuel is supplied to the fuel tank;
a combustion condition determination means for determining a combustion condition in each cylinder; and
a changing means for obtaining a varying correction value suitable for the fuel based on the combustion condition determined by the combustion condition determination means, and changing or correcting the air-fuel-ratio learning correction value based on the varying correction value.

2. A controller according to claim 1, wherein
the injection quantity varying control means establishes the varying correction value for each cylinder in such a manner that the air-fuel ratio does not exceed a combustion limit in at least one cylinder with respect to a whole range where the alcohol concentration varies and the combustion conditions in each cylinder are different from each other.

3. A controller according to claim 1, wherein
the combustion condition determination means determines the combustion condition in each cylinder according to a speed variation of the engine when a driving condition of the engine is stable.

4. A controller according to claim 1, wherein
the injection quantity varying control means repeatedly performs the injection quantity varying control until a number of fuel injection in each cylinder reaches a specified number.

5. A controller according to claim 1, wherein
the injection quantity varying control means performs the injection quantity varying control after an integral value of the fuel injection quantity integrated from a starting of the engine exceeds a value corresponding to a volume of a fuel supply passage from a fuel tank to a fuel injector.
